(19) United States
(12) Patent Application Publication
(10) Pub. No.: US 2006/0114604 A1
(43) Pub. Date: Jun. 1, 2006

(54) Electronic device comprising recording and reproducing unit

(75) Inventors: Daisuke Shimizu, Echizen-shi (JP); Hidenobu Mukougawa, Echizen-chi (JP); Takayuki Horie, Echizen-shi (JP); Yasuo Mitomori, Echizen-shi (JP); Tsuyoshi Yoshida, Echizen-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 11/281,608

(22) Filed: Nov. 18, 2005

(30) Foreign Application Priority Data
Nov. 30, 2004 (JP) 2004-347550

(51) Int. Cl. G11B 5/016

(52) U.S. Cl. 360/99.04

(57) ABSTRACT

An electronic device comprising a recording and reproducing unit is provided to further comprise a chassis, wherein a guide protrusion 14 for receiving and supporting one side end of a circuit board 20 is provided on a rise face 12 of a side end of a chassis 10; a protrusion portion is formed on a chassis bottom part 11, the protrusion portion receiving and supporting the other side end of the circuit board 20, the protrusion portion commonly supporting and fixing a recording and reproducing unit 30 together with the other side end of the circuit board 20. Further, a stepped portion for guiding the other side end of the board 20 is provided at the protrusion portion.

### BACKGROUND OF THE INVENTION

1. Field of the Invention

The present invention relates to an electronic device comprising a recording and reproducing unit. More particularly, the present invention relates to an electronic device capable of supporting and fixing a circuit board and a recording and reproducing unit on a chassis in common.

2. Description of the Related Art

Conventionally, in a process for mounting an electronic device which comprises a recording and reproducing unit such as a disk unit, there has been generally provided an assembling structure of carrying out mounting and fixing by using screw parts when a plurality of circuit boards or disk units are assembled to be fixed to a chassis or a case and the like. Therefore, in manufacturing a conventional electronic device or the like, tightening parts including mounting and fixing screws, nuts, washers or the like has been essential, and generally complicated work processes such as screw hole processing and screw tightening are required. Thus, further improvement of work efficiency has not been achieved, and further reduction of a manufacturing cost has not been successfully achieved.

In order to overcome the above described problems, in Japanese Patent Application Laid-open No. 8-116184, there is disclosed a structure of providing a plurality of columns which correspond to a plurality of screw holes in an upper case and a lower case opposed to each other, of an electronic device or the like, and further, sandwiching a circuit board having provided thereon screw holes which correspond to positions of the plurality of columns between both of the cases. There is also disclosed a structure of screw tightening the upper case and the lower case in a form which penetrates the circuit board, thereby fixing the circuit board sandwiched therebetween. With the structure of Japanese Patent Application Laid-open No. 8-116184, it becomes possible to mount a circuit board at the same time when casing is assembled. In addition, a work direction at the time of assembling and disassembling associated with screw removal can be unified to only a vertical direction, making it possible to reduce the assembling steps and the number of assembling parts such as screws.

Further, in Japanese Patent Application Laid-open No. 5-275869, there is disclosed a structure of engaging interposed parts such as a circuit board sandwiched between an upper case and a lower case opposed to each other, of an electronic device or the like via engagement means provided in the upper case, the lower case and front and rear face covers, and then, screw tightening the upper case and the lower case in a form which penetrates interposed parts such as the circuit board sandwiched between the cases, thereby fixing the interposed parts. With the structure of Japanese Patent Application Laid-open No. 5-275869, as in the structure of Japanese Patent Application Laid-open No. 8-116184, it becomes possible to mount the interposed parts such as a circuit board at the same time when casing is assembled. In addition, a work direction at the time of assembling and disassembling associated with screw removal can be unified to only a vertical direction, making it possible to reduce the assembling steps and the number of assembling parts such as screws.

Furthermore, in Japanese Patent Application Laid-open No. 7-176874, in an electronic device or the like which consists of a first housing and a second housing, the first housing having two side walls which form an L shape, and the second housing having four side walls which form a hexahedron-shaped housing in combination with the first housing, there is disclosed a structure of a housing main body in which circuit boards are housed in the step of assembling the housing main body of the electronic device, by combining and assembling the first housing with the second housing, wherein a first circuit board is mounted on the first housing, and a second circuit board is inserted and engagingly locked on the second housing by a holding protrusion and a holding receptacle groove, the holding protrusion and the holding receptacle groove provided on two opposed side wall in-planes of the second housing for inserting and engagingly locking the second circuit board, and female and male hooking means further provided at predetermined positions which correspond to each other in the second housing. With the structure of Japanese Patent Application Laid-open No. 7-176874, it becomes possible to reduce the assembling steps, and at the same time, to eliminate use of screw parts or the like for fixing a circuit board.

### DISCLOSURE OF THE INVENTION

With the above described structure, reduction of the assembling steps and reduction of the number of parts such as screws required to fix a circuit board has been achieved. However, in the structures of Japanese Patent Application Laid-open Nos. 8-116184 and 5-275869, except a case in which a single circuit board is sandwiched between the upper case and the lower case, assuming that a plurality of circuit boards are assembled to be sandwiched between the upper case and the lower case, unless vertical and horizontal dimensions are set to be substantially equal to each other with respect to all of the plurality of circuit boards sandwiched between the cases, the constructions of the columns in Japanese Patent Application Laid-open No. 8-116184 and the engagement means in Japanese Patent Application Laid-open No. 5-275869 become complicated, thus forcing an undesired burden in the course of a circuit board design and a housing design. As a result, it is considered that there occurs an inconvenience that the number of assembling parts such as screws is forced to be increased. Similarly, in the structure of Japanese Patent Application Laid-open No. 7-176874 as well, in the case where a plurality of circuit boards are housed in a housing of an electronic device main body, unless vertical and horizontal dimensions are set to be substantially equal to each other with respect to all of the plurality of circuit boards, there is an inconvenience that assembling becomes difficult.

Further, in the case where one specific board is removed from the electronic device main body due to repair and maintenance of the electronic device, in the structures of Japanese Patent Application Laid-open No. 8-116184 and Japanese Patent Application Laid-open No. 5-275869, all of the plurality of circuit boards sandwiched between the upper case and the lower case are removed at the same time, including a circuit board which may not be removed. Thus, while repair or maintenance is carried out, it is necessary to maintain in another place a circuit board which does not require repair and which has not been essentially required to be removed. Further, it is unavoidable to do a work of combining a repaired circuit board with a circuit board which does not require repair and has been separately maintained after removed in advance at the time of terminating repair or maintenance, and then, retightening all the circuit boards. Therefore, there is a problem that work efficiency becomes worse.

Furthermore, in Japanese Patent Application Laid-open No. 8-116184, Japanese Patent Application Laid-open No. 5-275869, and Japanese Patent Application Laid-open No. 7-176874, only a circuit board is explicitly shown as specific interposed parts to be tightened with a housing such as an electronic device, and nothing is mentioned as to tightening of a recording and reproducing unit such as a disk reproducing unit. Therefore, it is unclear as to whether or not a recording and reproducing unit which is much heavier than a circuit board can be supported with the structures of Japanese Patent Application Laid-open No. 8-116184, Japanese Patent Application Laid-open No. 5-275869 and Japanese Patent Application Laid-open No. 7-176874. However, even if supporting is possible, as described above, there exists a problem that all dimensions must be set to be substantially equal to each other with respect to a plurality of interposed parts. Similarly, there exists an inefficiency problem that, at the time of repair or maintenance of an electronic device or the like, all of the plurality of interposed parts are temporarily removed, including a circuit board which does not require repair and which has not been essentially required to be removed, and further, at the time of terminating repair or maintenance, a repaired circuit board must be retightened in combination with all of the interposed parts together with other circuit boards or the like which does not require repair.

### SUMMARY OF THE INVENTION

In order to solve the above-described problems, the present invention provides an electronic device comprising a recording and reproducing unit comprising: a chassis serving as a bottom face of the device; a recording and reproducing unit mounted upwardly of the chassis; and a board for controlling the device, wherein there is provided receiving and supporting means for supporting one end of the board at a side end of the chassis, and wherein there is provided supporting and fixing means capable of supporting the other end of the board at an opposite side end of the chassis and fixing the recording and reproducing unit and the board to the chassis. Further, in the above-described electronic device comprising a recording and reproducing unit, the present invention provides an electronic device comprising a recording and reproducing unit, wherein a rise face erected upwardly of the side end of the chassis is formed, and wherein a guide protrusion cut and formed at an inside of the rise face is used as receiving and supporting means of the board. Further, the present invention provides an electronic device comprising a recording and reproducing unit, wherein a protrusion portion protruded upwardly of a bottom face of the chassis is formed; a stepped portion for guiding the other end of the board and a tightening hole for tightening the recording and reproducing unit and/or the board are provided at the protrusion portion; and the protrusion portion, the stepped portion, and the tightening hole are used as supporting and fixing means. Further, in the above-described electronic device comprising a recording and reproducing unit, the present invention provides an electronic device comprising a recording and reproducing unit, wherein a cutout for releasing the receiving and supporting means and/or the supporting and fixing means is formed at an end of the board; and wherein a predetermined gap is provided between a position of the receiving and supporting means and/or the supporting and fixing means and a position of the cutout in a state in which the board has been mounted upwardly of the chassis. Further, in the above-described electronic device comprising a recording and reproducing unit, the present invention provides an electronic device comprising a recording and reproducing unit, wherein, upwardly of the chassis, the board is disposed at both sides of the recording and reproducing unit.

According to the present invention, in an electronic device comprising a circuit board and a recording and reproducing unit, one side end of the circuit board and one side end of the recording and reproducing unit are supported and fixed in common, thereby achieving reduction of the number of tightening parts such as screws and reduction of the number of assembling work steps according to the tightening work. In addition, at the time of repair or maintenance, it becomes possible to remove only a circuit board which is required to be repaired. As a result, reduction of a manufacturing cost and a repair and maintenance cost can be achieved through reduction of the number of parts and reduction of the number of work steps.

### BRIEF DESCRIPTION OF THE DRAWINGS

FIG. 1 is a perspective view showing constituent elements of an electronic device according to a first embodiment of the present invention;

FIG. 2 is a perspective view showing a state in which a circuit board has been mounted on a chassis in the first embodiment of the present invention;

FIG. 3 is a perspective view showing a state before a disk reproducing unit is mounted on the chassis in the first embodiment of the present invention;

FIG. 4 is a perspective view showing a state in which the disk reproducing unit has been mounted on two circuit boards mounted on the chassis in the first embodiment of the present invention;

FIG. 5 is a plan view showing constituent elements of the electronic device according to the first embodiment of the present invention;

FIG. 6 is a plan view showing a state of a process for slidably inserting a circuit board into the chassis in the first embodiment of the present invention;

FIG. 7 is a plan view showing a state of an electronic device having mounted thereon all of the constituent elements according to an embodiment of the present invention;

FIG. 8 is a partially enlarged front view showing a part of a state in which a circuit board and a disk reproducing unit have been mounted at a chassis bottom part in the first embodiment of the present invention;

FIG. 9 is a partially enlarged perspective view showing a structure of a protrusion portion according to an embodiment of the present invention;

FIG. 10 is a partially enlarged perspective view showing a sectional shape of the protrusion portion according to an embodiment of the present invention;

FIG. 11 is a perspective view showing a state in which constituent elements of the electronic device are removed in the first embodiment of the present invention;

FIG. 12 is a perspective view showing a state after a circuit board has been removed in an embodiment of the present invention;

FIG. 13 is a perspective view showing constituent elements according to a second embodiment of the present invention;

FIG. 14 is a perspective view showing a state in which constituent elements of an electronic device are removed in the second embodiment of the present invention;

FIG. 15 is a perspective view showing a state in which a circuit board is moved upwardly in the second embodiment of the present invention;

FIG. 16 is a plan view showing constituent elements according to the second embodiment of the present invention; and

FIG. 17 is a plan view showing a state in which the circuit board is slidably moved in the second embodiment of the present invention.

### DESCRIPTION OF THE PREFERRED EMBODIMENTS

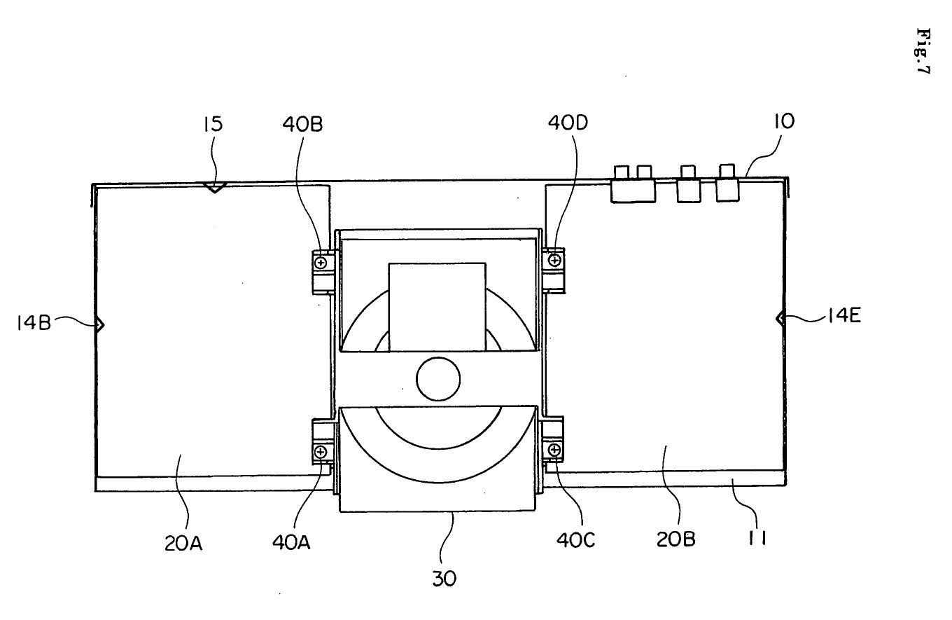

Hereinafter, specific embodiments according to the present invention will be described with reference to the accompanying drawings. FIG. 7 is a plan view showing a state of an electronic device on which all of the constituent elements have been mounted according to an embodiment of the present invention. The electronic device in the present embodiment is assumed to be composed of two circuit boards 20A and 20B and one disk reproducing unit 30 which are main parts of the device, as shown in FIG. 7. In addition, the disk reproducing unit 30 is assumed to have been designed so as to be set in a positional relationship such that the unit is sandwiched between the two circuit boards 20A and 20B.

### First Embodiment

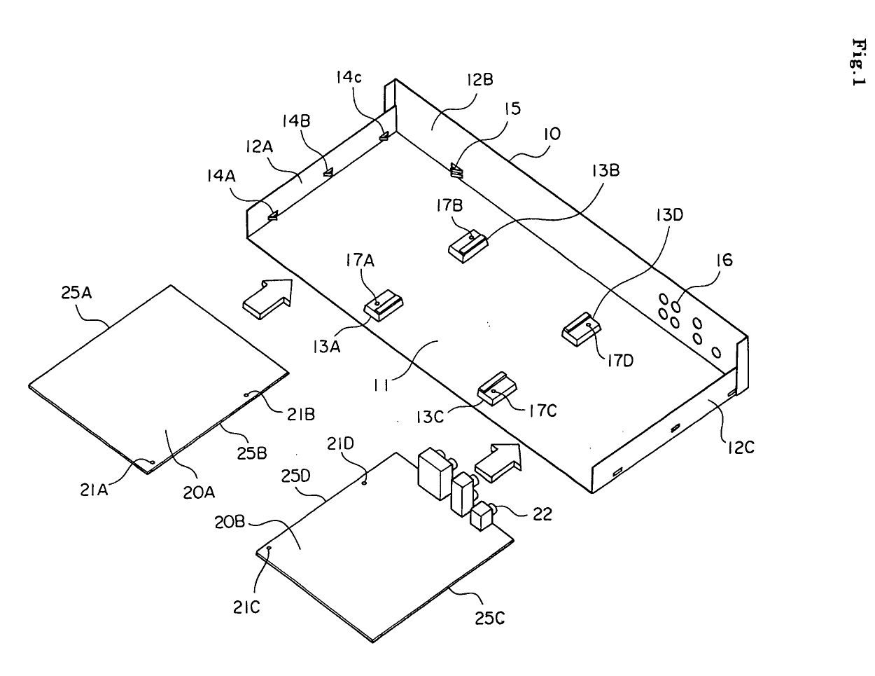

FIG. 1 is a perspective view showing constituent elements of an electronic device according to a first embodiment of the present invention. In the electronic device, a chassis 10 for mounting a recording and reproducing unit such as a disk reproducing unit is composed of a bottom part 11 and three rise faces 12A, 12B, and 12C erected in a vertical direction with respect to the bottom part 11. At the bottom part 11, a protrusion portion 13 is integrally formed upwardly from the bottom part 11, and guide protrusions 14 are integrally formed on both of the opposed rise faces 12A and 12C of the chassis.

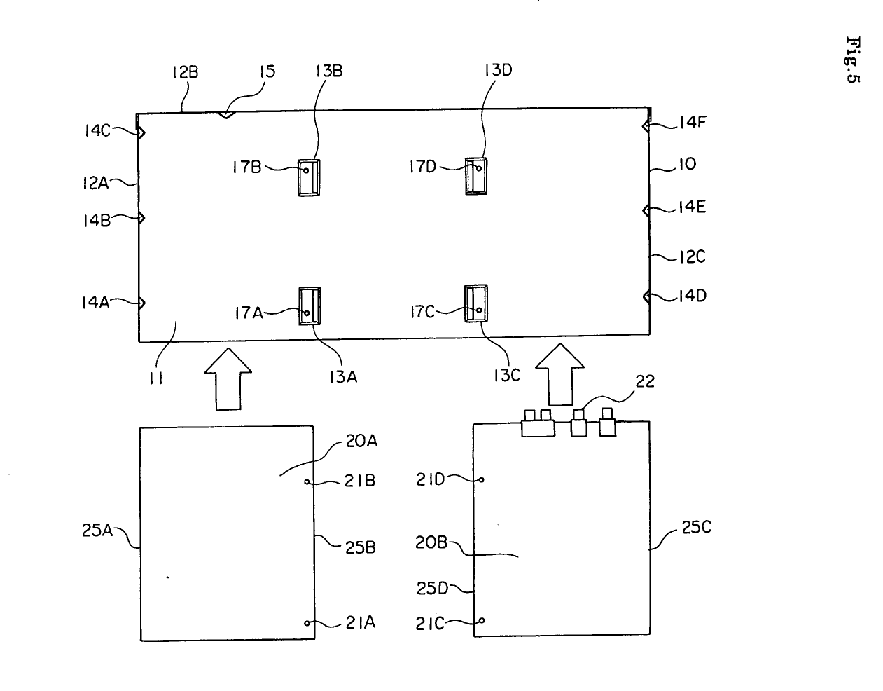

Now, with reference to FIG. 5 which is a plan view showing constituent elements of the electronic device according to the first embodiment of the present invention, a detailed description will be given with respect to a constructional correlation which the protrusion portion 13 and the guide protrusion 14 have with respect to each one of the two circuit boards 20A and 20B. When the circuit board 20 is mounted on the chassis 10, guide protrusions 14A, 14B, and 14C corresponding to a first side end 25A of a first circuit board 20A are provided on a first rise face 12A of the chassis for receiving and supporting the first side end 25A of the first circuit board 20A; and protrusion portions 13A and 13B are provided on a chassis bottom part 11 for receiving and supporting a second side end 25B parallel to the first side end 25A of the first circuit board 20A. In the meantime, guide protrusions 14D, 14E, and 14F corresponding to a first side end 25C of a second circuit board 20B are provided on a second rise face 12C of the chassis for receiving and supporting the first side end 25C of the second circuit board 20B; and protrusion portions 13C and 13D are provided on the chassis bottom part 11 for receiving and supporting a second side end 25D parallel to the first side end 25C of the second circuit board 20B. Here, said protrusion portions 13A, 13B, 13C, and 13D correspond to supporting and fixing means for mounting a leg part of a disk reproducing unit described later on the chassis 10.

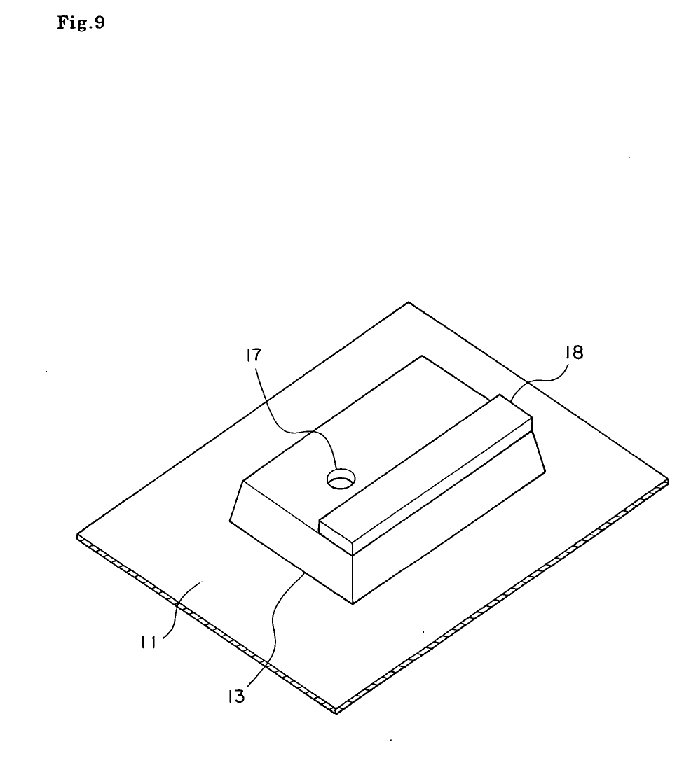

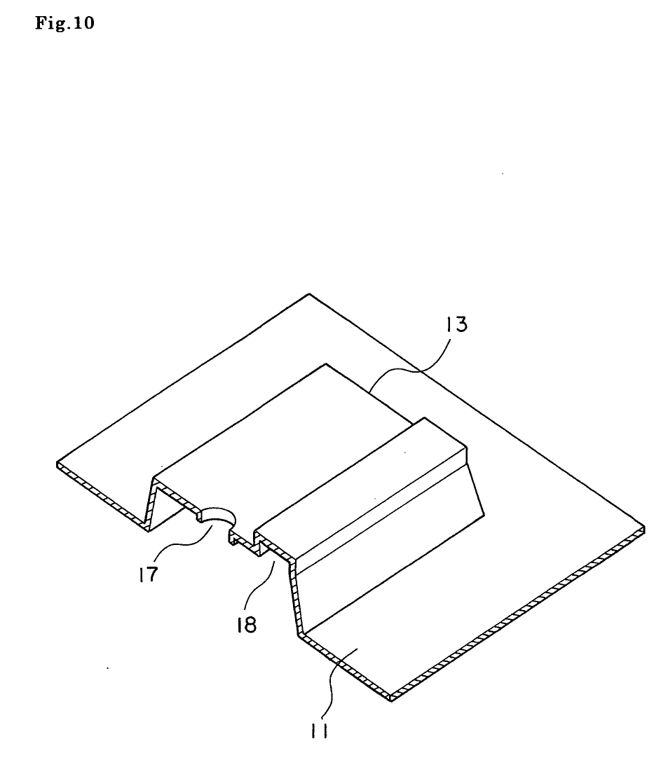

Now, with reference to FIG. 9, a structure of the protrusion portion 13 integrally formed on the chassis bottom part 11 will be described below. FIG. 9 is a partially enlarged perspective view showing a structure of the protrusion portion 13. At the protrusion portion 13, a screw tightening hole 17 is formed at a position which corresponds to both of a mount screw hole formed at a predetermined position of a leg part of the disk reproducing unit and a screw through hole 21 of the circuit board 20 described later, the screw through hole corresponding to the mount screw hole. Further, a protrusive board guide portion 18 having a predetermined step for guiding the circuit board 20 is integrally formed. FIG. 10 is an enlarged perspective view showing a sectional shape of the protrusion portion 13.

Now, a description will be given with respect to the circuit board 20 which is one of the constituent elements of the electronic device according to the first embodiment of the present invention. In the two circuit boards 20A and 20B shown in FIG. 5, when the circuit board 20 is mounted on the chassis 10, at the proximal edge of the second side end 25B parallel to the first side end 25A of the first circuit board 20A received and supported by the first rise face 12A of the chassis, screw through holes 21A and 21B are formed at the positions which correspond to screw tightening holes 17A and 17B formed on the protrusion portions 13A and 13B described above. Similarly, at the proximal edge of the second side end 25D parallel to the first side end 25C of the second circuit board 20B received and supported by the second rise face 12C of the chassis, screw through holes 21C and 21D are formed at the positions which correspond to screw tightening holes 17C and 17D formed on the protrusion portions 13C and 13D described above.

Further, a description will be given with respect to the disk reproducing unit 30 which is one of the constituent elements of the electronic device according to the first embodiment of the present invention. In the present embodiment, as shown in FIG. 7, the disk reproducing unit 30 is designed so as to be set in positional relationship such that the unit is sandwiched between the two circuit boards 20A and 20B. Mount screw holes (not shown) corresponding to screws 40A, 40B, 40C, and 40D for tightening the disk reproducing unit 30 onto the chassis bottom part 11 are formed at the predetermined portions of a leg part of the disk reproducing unit.

Based on the construction described above, first, a step of mounting two circuit boards 20A and 20B on a chassis 10 will be described with respect to an operation of the first embodiment according to the present invention. As shown in FIG. 1, the first circuit board 20A is slidably inserted into a chassis 10 in a direction indicated by the arrow. A first side end 25A of the first circuit board 20A is received and supported by means of guide protrusions 14A, 14B, and 14C provided on a first rise face 12A of the chassis 10. In the present embodiment, the guide protrusion 14A and the guide protrusion 14C are arranged so as to support a lower surface of the first circuit board 20A to be slidably inserted, and the guide protrusion 14B is arranged so as to support an upper surface of the first circuit board 20A to be slidably inserted. The guide protrusions 14 are formed and positioned with a level difference which corresponds to the thickness of the first circuit board 20A so that the first circuit board 20A can be pinched. These guide protrusions 14 correspond to receiving and supporting means for receiving and supporting at least one side end of the circuit board 20.

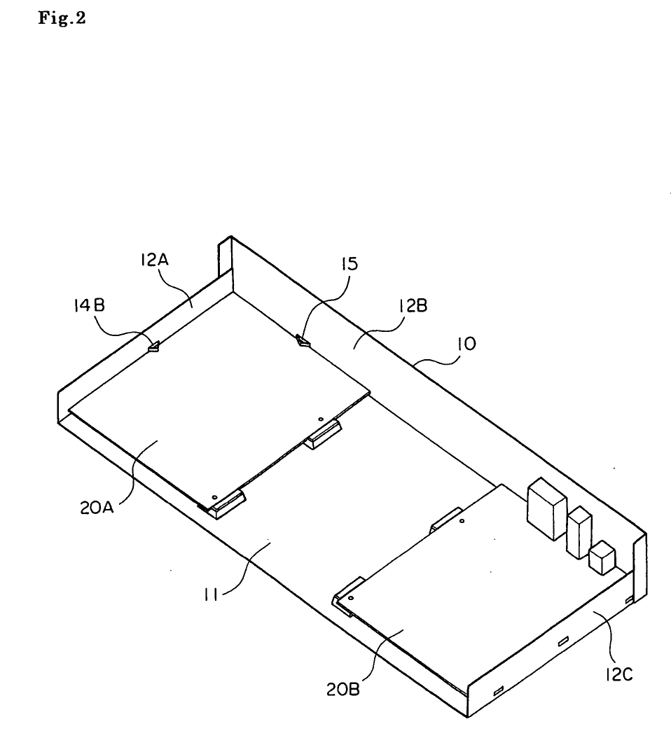

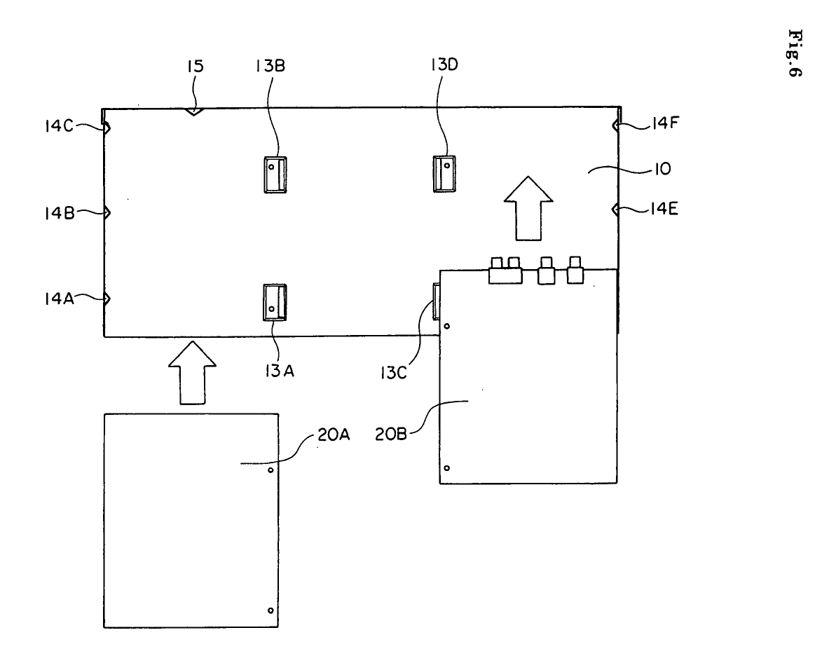

In addition, as shown in FIG. 1, when the first circuit board 20A is slidably inserted into the chassis 10 in a direction indicated by the arrow, a second side end 25B of the first circuit board 20A is received and supported by a protrusive board guide portion 18 (refer to FIGS. 9 and 10) having a predetermined step provided at protrusion portions 13A and 13B of the chassis bottom part 11. Further, when the first circuit board 20A is slidably inserted into the predetermined position, the step of the slidable insertion terminates so that screw through holes 21A and 21B formed on the first circuit board 20A are associated with screw tightening holes 17A and 17B formed on the protrusion portions 13A and 13B. With respect to the second circuit board 20B as well, slidably insertion into the chassis 10 is completed through the step which is completely identical to that of the first circuit board 20A. FIG. 2 is a perspective view showing a state in which the two circuit boards 20A and 20B have been mounted on the chassis 10. FIG. 6 is a plan view showing a state of a process for slidably inserting the circuit board 20 into the chassis 10.

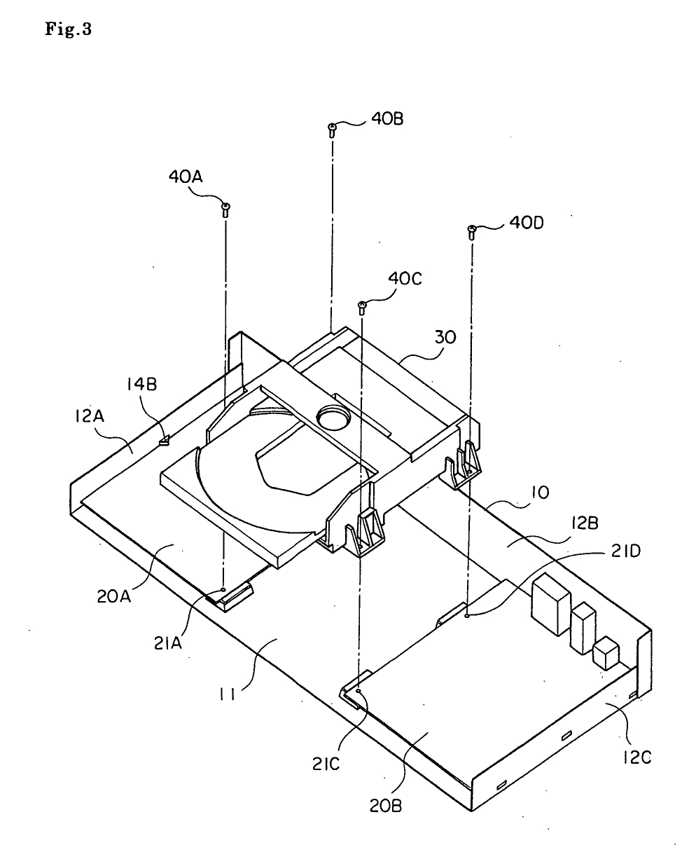

Now, a step of mounting a disk reproducing unit 30 on the chassis 10 will be described below. FIG. 3 is a perspective view showing a state before the disk reproducing unit 30 is mounted on the chassis 10. As shown in FIG. 3, in a state in which screw through holes 21A and 21B formed on the first circuit board 20A and screw through holes 21C and 21D formed on the second circuit board 20B are associated with screw tightening holes 17A, 17B, 17C, and 17D formed on the protrusion portions 13A, 13B, 13C, and 13D provided on the chassis bottom part 11, respectively, the two circuit boards 20A and 20B are already mounted on the chassis bottom part 11 through the above described step.

When the disk reproducing unit 30 is installed on the two circuit boards 20A and 20B mounted on the chassis 10, mount screw holes (not shown), formed at the predetermined positions of a leg part of the disk reproducing unit 30, the screw holes corresponding to screws 40A, 40B, 40C, and 40D for tightening the disk reproducing unit 30 on the chassis bottom part 11, are positioned in a state which corresponds to the screw through holes 21A and 21B formed on the first circuit board 20A and the screw through holes 21C and 21D formed on the second circuit board 20B.

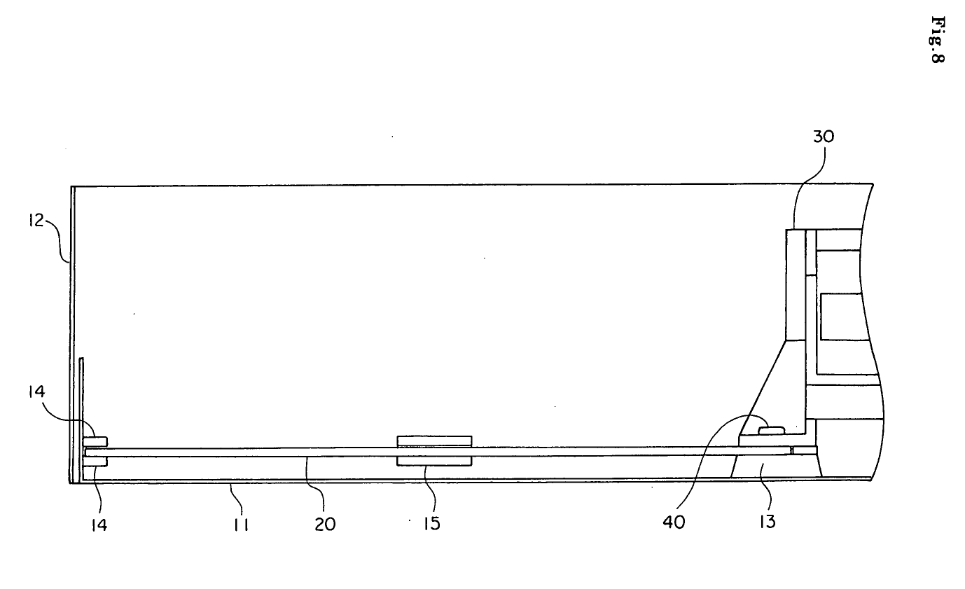

In this manner, the mount screw holes (not shown) formed at the leg part of the disk reproducing unit 30; the screw through holes 21A, 21B, 21C, and 21D formed on the two circuit boards 20A and 20B; and the screw tightening holes 17A, 17B, 17C, and 17D formed on the protrusion portions 13A, 13B, 13C, and 13D of the chassis bottom part 11 are disposed at their corresponding positions. Thus, the screws 40A, 40B, 40C, and 40D can be helically fitted to the screw tightening holes 17A, 17B, 17C, and 17d formed on the protrusion portions 13A, 13B, 13C, and 13D of the chassis bottom part 11 through the mount screw holes (not shown) of the disk reproducing unit 30 and the screw through holes 21A, 21B, 21C, and 21D of the two circuit boards 20A and 20B. FIG. 8 is a partially enlarged front view showing a part of a state in which the circuit board 20 and the disk reproducing unit 30 have been mounted on the chassis bottom part 11.

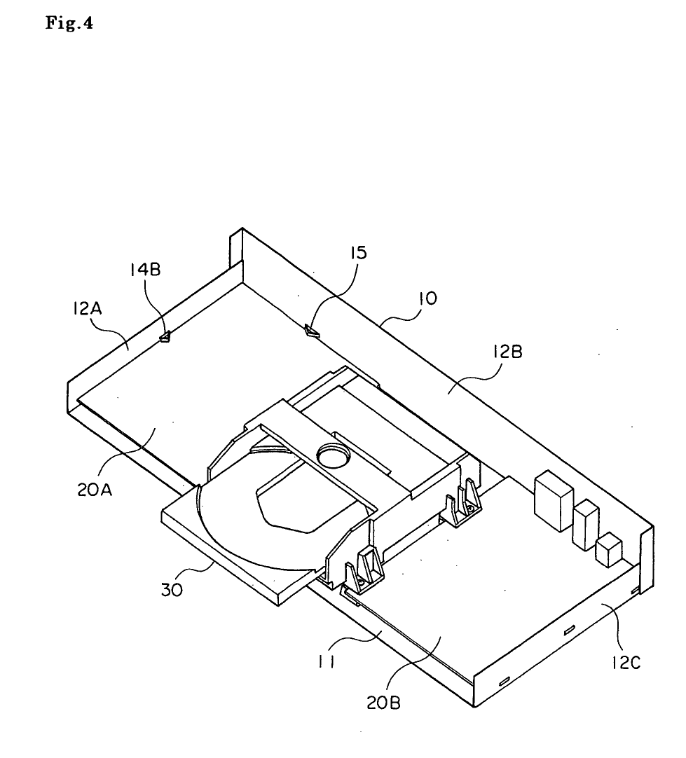

FIG. 4 is a perspective view showing a state in which the disk reproducing unit 30 has been mounted on the two circuit boards 20A and 20B mounted on the chassis 10 according to the embodiment. As in the present embodiment, in the case where three mount members composed of two circuit boards and one disk reproducing unit are fixed to the chassis, if these mount members are screw-tightened with the chassis separately on a one by one basis, four screws are required for one of the mount members, and a total of twelve screws are required. However, as described above, according to the present invention, it is possible to provide a structure of tightening and fixing one side end of each of the two circuit boards by means of screws together with the disk reproducing unit and receiving and supporting the other side end of each of the two circuit boards by means of guide protrusions provided on each rise face of the chassis. Thus, twelve screws can be reduced to four screws. In this manner, it becomes possible to reduce the number of parts required to configure the electronic device and to reduce the number of work steps in a process for assembling the electronic device.

A description of operation has been now completed in the case where two circuit boards and one disk reproducing unit are mounted on a chassis. Now, an additional description of operation will be given in the case of removing one circuit board from among two circuit boards and one disk reproducing unit mounted on a chassis for the purpose of repair or maintenance.

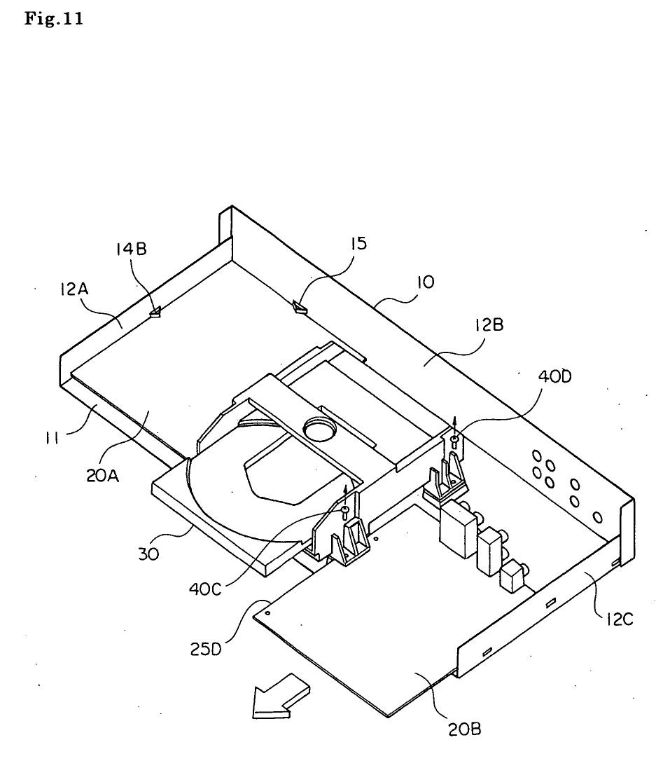

An electronic device requiring repair or maintenance is brought in, in a state in which the two circuit boards 20A and 20B and one disk reproducing unit 30 are tightened and fixed by means of the screws 40A, 40B, 40C, and 40D altogether. Now, an embodiment will be described assuming that the second circuit board 20B is replaced with its replacement board due to some failure. As shown in FIG. 11, by removing the screws 40C and 40D, common screw tightening of the leg part of the disk reproducing unit 30 and the first side end 25D of the second circuit board 20B at the protrusions 13C and 13D of the chassis bottom part 11 is released. As shown in FIG. 8, the screw 40 is removed, whereby only the circuit board 20 can be slid to be removed along the board guide portion 18 formed at the protrusion portion 13 without removing the disk reproducing unit 30 from the protrusion portion 13 formed on the chassis bottom part 11.

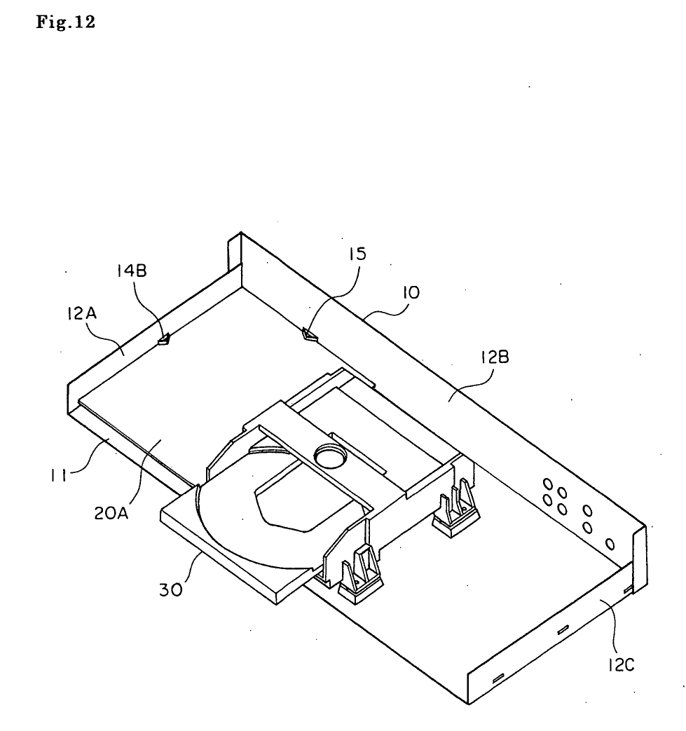

FIG. 11 shows a state in which the second circuit board 20B to be removed is removed while it is slid in a direction indicated by the arrow along the board guide portion 18 described above. FIG. 12 is a perspective view showing a state after the second circuit board 20B has been removed. According to the present invention, at the time of repair or maintenance, in the case where only a specific circuit board is replaced with its replacement board from the electronic device, only the specific circuit board can be removed easily by merely removing two screws. Thus, reduction of the steps associated with repair or maintenance and cost reduction can be achieved.

### Second Embodiment

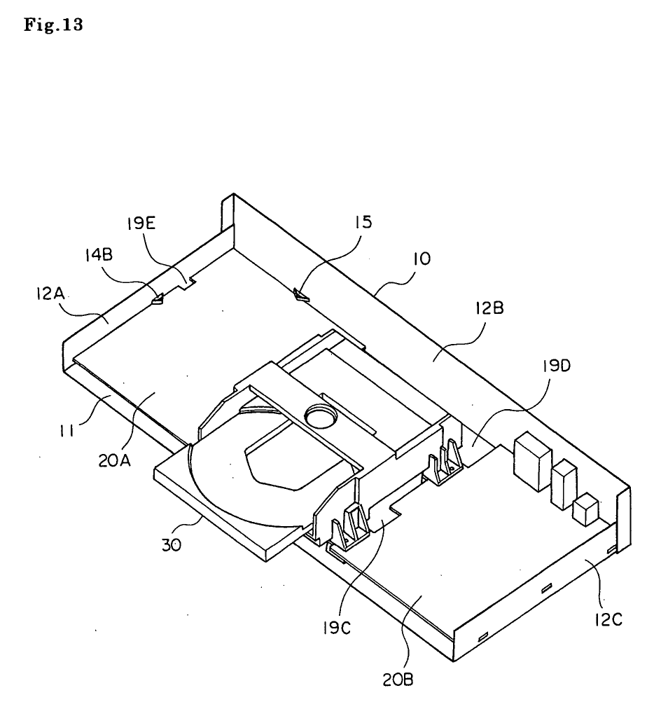

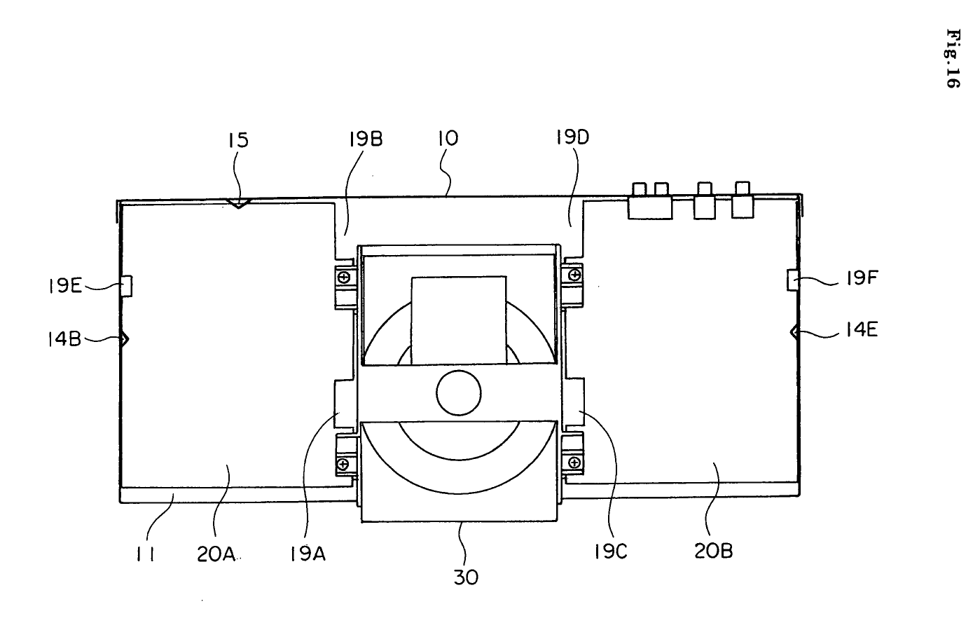

Now, a second embodiment according to the present invention will be described with reference to FIGS. 13 to 17. Constituent elements according to the second embodiment are featured in that a cutout is formed on each of two circuit boards 20A and 20B. FIG. 13 is a perspective view showing constituent elements in the second embodiment according to the present invention, and FIG. 16 is a plan view showing constituent elements in the second embodiment according to the present invention. The structures of a chassis 10 and a disk reproducing unit 30 are completely identical to those according to the first embodiment, including a guide protrusion 14 and a protrusion portion 13 integrally formed on the chassis 10. A duplicate description is omitted here. Now, with reference to FIG. 16, a detailed description will be additionally given with respect to the cutouts formed on the circuit boards 20A and 20B.

Three cutouts 19A, 19B, and 19E are formed on the first circuit board 20A, and three cutouts 19C, 19D, and 19F are formed on the second circuit board 20B, respectively. With cross-reference to FIG. 16 against FIG. 7 illustrating the constituent elements according to the first embodiment, it is possible to help understanding of a position relationship of the above cutouts. The cutouts 19A and 19B formed on the first circuit board 20A and the cutouts 19C and 19D formed on the second circuit board 20B shown in FIG. 16 correspond to the protrusion portions 13A, 13B, 13C, and 13D shown in FIG. 5, respectively. In addition, the cutout 19E formed on the first circuit board 20A and the cutout 19F formed on the second circuit board 20B shown in FIG. 16 correspond to guide protrusions 14B and 14E shown in FIG. 5, respectively. In this manner, the protrusion portion 13 and the guide protrusion 14 formed on the chassis 10 can be inserted through the cutout 19 formed on the corresponding circuit board 20.

In a state in which a predetermined positional relationship is maintained to be equal to a relative positional relationship between each of the protrusion portions 13A and 13B and the guide protrusion 14B, the cutouts 19A, 19B, and 19E are formed at the predetermined positions of the first circuit board 20A. Similarly, in a state in which a predetermined positional relationship is maintained to be equal to a relative positional relationship between each of the protrusion portions 13C and 13D and the guide protrusion 14E, the cutouts 19C, 19D, and 19F are formed at the predetermined positions of the second circuit board 20B. The above predetermined positions for forming the above cutouts 19A, 19B, 19E, 19C, 19D, and 19F are defined so as not to overlap with sites at which the circuit boards 20A and 20B are mounted by means of common screw tightening together with the protrusion portions 13A, 13B, 13C, and 13D of the chassis bottom part 11 and a leg part of the disk reproducing unit 30.

Based on the above described construction, a description will now be given with respect to an operation in the second embodiment according to the present invention. An operation in the case where the two circuit boards 20A and 20B and one disk reproducing unit 30 are mounted on the chassis 10 is completely identical to that according to the first embodiment described previously. A duplicate description is omitted here. Here, an additional description will be given with respect to an operation in the case where the second circuit board 20B is removed from among the two circuit boards 20A and 20B and one disk reproducing unit 30 mounted on the chassis 10 for the purpose of repair or maintenance.

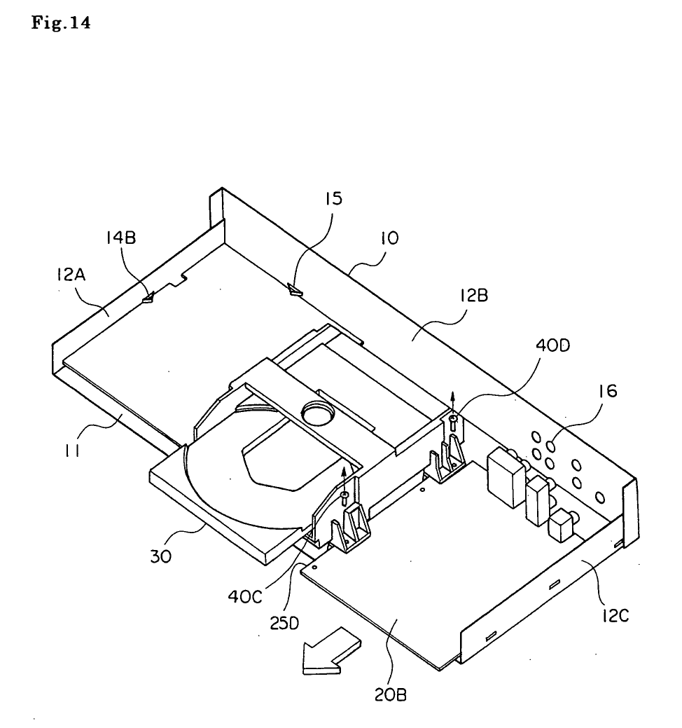

As is the case with the removal described in the first embodiment, first, as shown in FIG. 14, by removing screws 40C and 40D, common screw tightening of a leg part of the disk reproducing unit 30 and the first side end 25D of the second circuit board 20B at the protrusion portions 13C and 13D of the chassis bottom part 11 is released. Thus, only the second circuit board 20B can be slid in a direction indicated by the arrow along the board guide portion 18 formed at the protrusion portion 13 without removing the disk reproducing unit 30 from the protrusion portion 13 formed on the chassis bottom part 11.

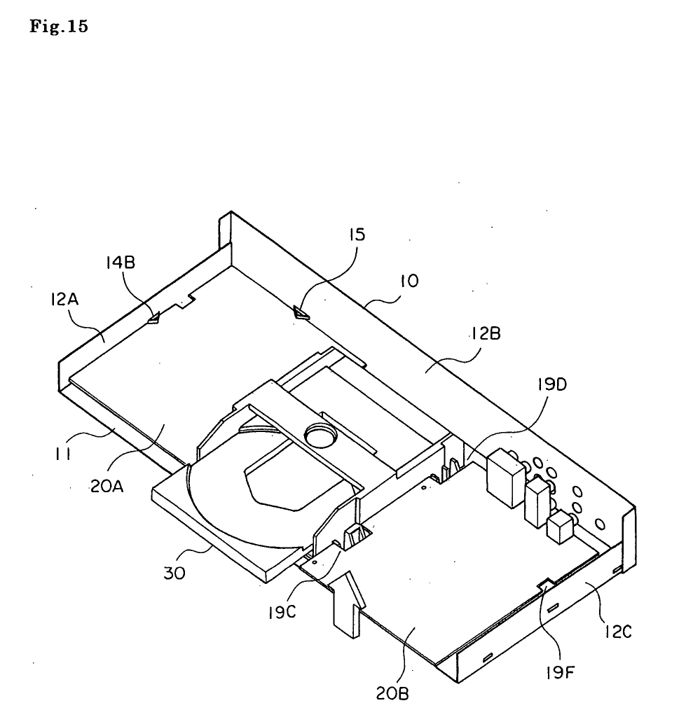

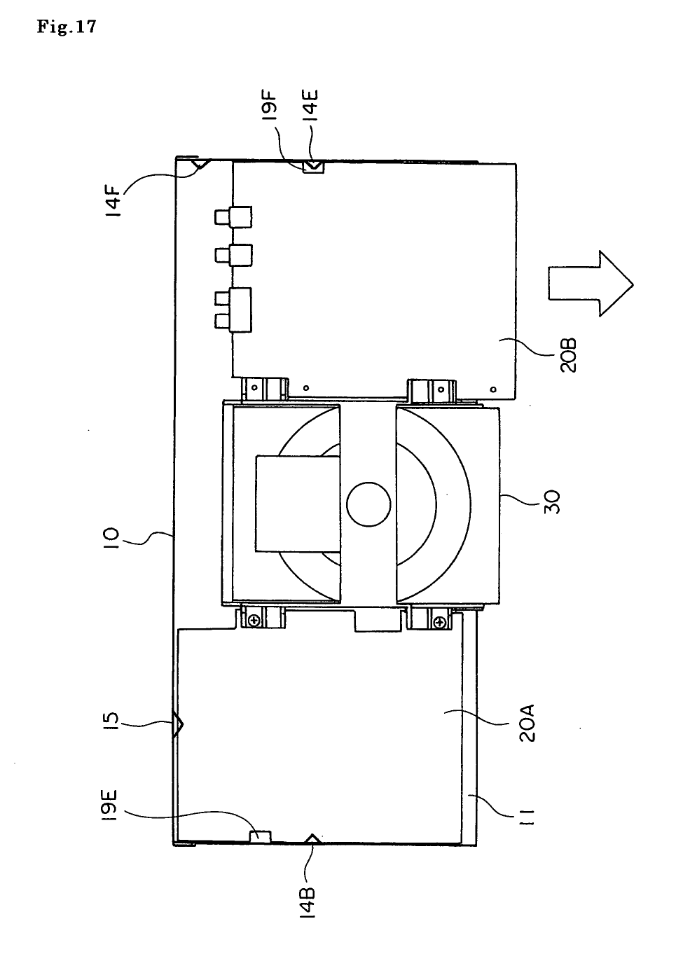

In the present embodiment, as shown in FIG. 17, slide movement of the second circuit board 20B in the direction indicated by the arrow is continued until the cutouts 19C, 19D, and 19F formed on the second circuit board 20B overlap with the positions of the protrusion portions 13C and 13D and a guide protrusion 14E formed on the chassis 10 in a relative positional relationship corresponding thereto. When the overlapped state is reached, slide movement of the second circuit board 20B is stopped, and the second circuit board 20B is moved upwardly, as shown in FIG. 15, whereby the second circuit board 20B can be easily removed without removing the disk reproducing unit 30 from the chassis 10, and moreover, merely by removing the two screws 40C and 40D.

According to the present embodiment, when a circuit board is removed at the time of repair or maintenance, a slide movement quantity of the circuit board in a depth direction is reduced, and instead, upward movement is carried out, thereby making it possible to reduce a movement quantity for removing the circuit board at a position proximal to a chassis or a disk reproducing unit and the like and to reduce a danger of contact with another member or the like at the time of a work of removing the circuit board.

In both of the above first embodiment and second embodiment as well, as shown in FIG. 1 or FIG. 14, on a rise face 12B of a chassis rear face portion, it is possible to integrally form a jack terminal through hole 16 for outwardly protruding a terminal portion of a jack terminal 22 mounted on the circuit board 20B or a pinch protrusion 15 for supporting the circuit board 20A, as the occasion demands.

While both of the above first embodiment and second embodiment have described that a guide protrusion is integrally formed on a rise face of a chassis and a protrusion portion is integrally formed on a chassis bottom part, it is possible to properly mount either of the guide protrusion and the protrusion portion as an additional member on a chassis without being integrally formed on the chassis.

While both of the above first embodiment and second embodiment have described that a recording and reproducing unit and a board are supported and fixed on a protrusion portion formed on a chassis in accordance with a screw tightening method, the supporting and fixing method is not limited thereto.

1. An electronic device comprising a recording and reproducing unit comprising:
a chassis serving as a bottom face of the device; a recording and reproducing unit mounted upwardly of the chassis; and
a board for controlling the device, wherein
there is provided receiving and supporting means for supporting one end of the board at a side end of the chassis, and wherein
there is provided supporting and fixing means capable of supporting the other end of the board at an opposite side end of the chassis and fixing the recording and reproducing unit and the board to the chassis.

2. The electronic device comprising a recording and reproducing unit according to claim 1, wherein a rise face erected upwardly of the side end of the chassis is formed, and wherein a guide protrusion cut and formed at an inside of the rise face is used as receiving and supporting means of the board.

3. The electronic device comprising a recording and reproducing unit according to claim 1, wherein a protrusion portion protruded upwardly of a bottom face of the chassis is formed; a stepped portion for guiding the other end of the board and a tightening hole for tightening the recording and reproducing unit and/or the board are provided at the protrusion portion; and the protrusion portion, the stepped portion, and the tightening hole are used as supporting and fixing means.

4. The electronic device comprising a recording and reproducing unit according to claim 1, wherein a cutout for releasing the receiving and supporting means and/or the supporting and fixing means is formed at an end of the board; and wherein a predetermined gap is provided between a position of the receiving and supporting means and/or the supporting and fixing means and a position of the cutout in a state in which the board has been mounted upwardly of the chassis.

5. The electronic device comprising a recording and reproducing unit according to claim 1, wherein, upwardly of the chassis, the boards are disposed at both sides of the recording and reproducing unit.

6. The electronic device comprising a recording and reproducing unit according to claim 2, wherein a cutout for releasing the receiving and supporting means and/or the supporting and fixing means is formed at an end of the board; and wherein a predetermined gap is provided between a position of the receiving and supporting means and/or the supporting and fixing means and a position of the cutout in a state in which the board has been mounted upwardly of the chassis.

7. The electronic device comprising a recording and reproducing unit according to claim 3, wherein a cutout for releasing the receiving and supporting means and/or the supporting and fixing means is formed at an end of the board; and wherein a predetermined gap is provided between a position of the receiving and supporting means and/or the supporting and fixing means and a position of the cutout in a state in which the board has been mounted upwardly of the chassis.

8. The electronic device comprising a recording and reproducing unit according to claim 2, wherein, upwardly of the chassis, the boards are disposed at both sides of the recording and reproducing unit.

9. The electronic device comprising a recording and reproducing unit according to claim 3, wherein, upwardly of the chassis, the boards are disposed at both sides of the recording and reproducing unit.

10. The electronic device comprising a recording and reproducing unit according to claim 4, wherein, upwardly of the chassis, the boards are disposed at both sides of the recording and reproducing unit.

11. The electronic device comprising a recording and reproducing unit according to claim 6, wherein, upwardly of the chassis, the boards are disposed at both sides of the recording and reproducing unit.

12. The electronic device comprising a recording and reproducing unit according to claim 7, wherein, upwardly of the chassis, the boards are disposed at both sides of the recording and reproducing unit.
